(19) United States
(12) Patent Application Publication
(10) Pub. No.: US 2018/0374319 A1
(43) Pub. Date: Dec. 27, 2018

(54) A DEVICE FOR DETECTION THE FOREIGN OBJECTS PLACED, JAMMING THE DATA WITH DISRUPTIVE SIGNALS, ISSUING WARNING NOTICES AND RECORDING THE EVENTS IN ORDER TO PROTECT THE DATA ON THE CARDS USED IN THE PAYMENT STATIONS

(71) Applicant: EKSPER BILISIM HIZMETLERI SAN.VE TIC. LTD. STI., Istanbul (TR)

(72) Inventor: Tuncer DUDUOGLU, Istanbul (TR)

(73) Assignee: EKSPER BILISIM HIZMETLERI SAN.VE TIC. LTD. STI., Instanbul (TR)

(21) Appl. No.: 16/062,222

(22) PCT Filed: Dec. 31, 2015
(86) PCT No.: PCT/TR2015/000394

§ 371 Date: Jun. 14, 2018

(51) Int. Cl. G07F 19/00; H04K 3/00

(52) U.S. Cl. CPC G07F 19/2055; G07F 19/209; H04K 3/45; H04K 3/825; H04K 3/62; G07F 19/207

(57) ABSTRACT

A device is provided that is developed for use in both DIP and Motorized-type card readers installed in the card-operated payment stations usually and used for preventing the theft of the personal data stored in the payment card, to analyze and determine the foreign objects inserted in to the intake slot of the DIP or motorized card readers using a dynamic and adaptive software, to emit jamming signals in order to corrupt the data and prevent copying attempts, to prevent the physical entry of the card by activating a shutter system and to issue audible warnings to warn the users, to notify the central about the events taking place and to maintain the records of the events on the fixed memory card incorporated in the device.

### TECHNICAL FIELD

This invention is related to a device that can be used in the card readers installed in both types of card-operated payment stations (DIP and motorized), which the people use for payments directly, developed for preventing the theft of the personal data stored in the payment card, to analyze and determine the foreign objects placed in to the intake slot of the card reader, to emit disruptive signals in order to prevent copying attempts, if necessary close the card entry slot as preventive action, to send warning signals through various channels and issue audible warnings and to maintain the records of the events on the device.

### BACKGROUND OF THE INVENTION

The existing motorized card readers in the payment stations, which draw the card in when inserted and ejects the card the same way after the transaction is completed, detect the card by means of a switch (opening or closing when the card is inserted) send a jamming signal while the card is inserted or ejected in order to prevent the card from being copied based on the position of the said switch. Since the head that reads the data on the magnetic strip of the card in the motorized payment stations is located deeper inside the machine and away from the entrance, the jamming signal emitted does not affect the reader head, but prevents any foreign copying device placed in the card entry slot only. In the DIP type readers, the reader head is quite close to the card entrance slot. Therefore, a jamming signal emitted when the card is inserted would prevent the legitimate card reader from reading the card in the payment station, this signal should not be emitted each time the card is inserted, but when a foreign object is placed in the card entrance.

The device of the present invention is capable of detecting the foreign objects placed in the card entrance of the “DIP and Motorized Reader” card readers generally used in the payment stations for stealing the data on the customers' cards and once detected, emitting a jamming signal to prevent the theft and cutting off the power for activating the shutter mechanism to close the card entrance, whereas in the DIP type card readers shutting out the card entrance from service by means of the micro-shutter mechanism. Furthermore, the device can also detect the copying devices known as “razor skimming” placed in the card reader by means of the LVDT sensor. It can warn the users audibly with the voice module. It notifies the bank or security personnel with alarms and messages through various means of communication after detection and records such events on the incorporated memory card that can be expanded as needed in the format desired.

The invention detects any fixed foreign objects placed in front of the card reader and prevents the possibility of copying by emitting a jamming signal. It stops the jamming signal when the said fixed object is removed from the card reader and returns to the normal operating mode. It transmits the information on all such events to the relevant units by means of its communication features. The above features enable the device to provide a chance for intervention against the copying devices that can block or filter out the jammer signals or to prevent any malicious persons from retrieving the copying device with the stolen data even if a successful copy is made. Moreover, in the embodiment of the invention adapted for the motorized card readers, the sensors cause the power to the card reader be switched of as a result of a software decision, thereby causing entrance slot shutter to close automatically (and sending an error notice at the same time). Thus copying becomes impossible since the customers cannot insert their cards. This invention also allows for integrating an automatic closing feature for the shutters, which the DIP-type card readers do not have, in case of a malfunction and a mini shutter mechanism for the bezel designs, which cuts off the power in case of an alarm and prevents copying the cards by closing the card entrance slot physically. Because the installation of a skimming device is notified to the monitoring center in real time, it also allows collecting the evidence required for criminal prosecution as well.

The solution provided by the said invention enables emitting the jamming signal not only when the card passes through the motorized card signals, but when any foreign object is placed in front of the card reader also and preventing the insertion of the card by cutting off the power as specified by the customer and resuming the normal functions when the foreign object removed after running a few test cycles.

Because the existing devices designed for preventing copying by emitting a jamming signal when the card is inserted and ejected, do not issue any warning for the detection of the copying devices, when the advanced copying devices that use the filtering and blocking methods are successful, the situation becomes evident when the card is copied and used by the malicious persons only, but the data concerning where and when the copying was done still remains inaccessible.

There are other solutions for the DIP or motorized card readers in the existing systems. Although some of these devices attempt to detect any foreign objects placed in front of the card reader, the ability of detecting can be quite low due to the technologies used. Erroneous detection and false alarms may result if the customer holds the card in front of the card reader for a long time or due to the magnetic field or variable electrical field caused while using the mobile telephones, getting wet by rain drops or other sources in the card reader entrance, a fluorescent lamp operating nearby, a powerful light source or direct sun light falling on the card reader etc. Moreover, since such products are aimed at detecting only and do not protect the card reader by jamming, they put the payment card systems under risk until intervention is provided in response to the alarm issued.

In addition, the card can still be copied even after the foreign object is detected, that is until the response to the alarm from the payment system or because the entry of the card is not prevented physically despite shutting off the machine.

In some methods the card reader is preventing with an additional jamming signal like this invention, but the difference between this invention is that they emit the jamming signal continuously. But the continuous jamming signal affects its own reader as well and if the intensity of the jamming signal is lowered to reduce such an adverse effect, the copying signal may do the copying action successfully. In another method (PCT/NL2015/050182), the insertion of the card is detected by an entry sensor and a jamming signal is emitted for limited time until the card reaches the SST reader head, but the advanced skimming devices are capable of getting around or blocking the jamming signals by filtering, which effectively neutralizes the jamming device and result in a successful copying. But because such methods do not have an effective detection ability of the skimming devices, their utilization as a solution remains limited.

Some other devices can detect the copying device installed but cannot jam the device detected, which allows copying the card when the customer inserts the card until a response to the alarm issued by the payment system is provided.

The essential differences of our invention from the existing systems explained above are;
Highly accurate detection of the foreign objects installed in the card reader slot (specially manufactured translucent bezel with IR transparency, integrated IR LEDs and sensors).
The ability to distinguish the hand movements and fixed objects from the copying devices installed.
The ability to emit the jamming signals only when a threat is detected.
When the sensors integrated to the specially manufactured bezels for the motorized card readers detect any foreign objects, the ability to cut off the power to the card reader as a decision of our software in the processor (and to send an error notice at the same time) to shut down the system and close the card entrance automatically (with a shutter system) thus preventing the possibility of inserting the card. This invention also allows an automatically closing shutter in case of a malfunction, which is not available in the DIP-type card readers, by integrating a mini shutter into the special bezel designs, whereby the power is cut off in case of an alarm thus preventing copying by closing the card entrance physically.
Even if any copying device capable of filtering or blocking makes a successful copy, because the foreign object is detected immediately, stealing the data is prevented by timely intervention.
By integrating the LVDT technology in to the specially designed bezel and our processor, any foreign objects with different sizes or dimensions than the reference values are detected while inserting in to the card reader while attempting any Razor type copying. A series of measures including closing the card entrance of the card readers physically starting from the issuance of an alarm can be taken.
The records of the events detected by the device are kept on a Micro SD card with an expandable capacity integrated in to the control module in the desired format, which records such data continuously and locally even if the communications may be interrupted, thus allowing the retrieval of the data through a connection on the box.
The customers are informed about the out of order status of the payment station and that they should not insert their cards audibly in the languages and intervals desired by means of a Voice module integrated to the invention.
In short, it has the ability of detecting the foreign objects by means of an enhanced algorithm and emitting jamming signals of varying types and amplitudes through the multiple antenna, preventing the utilization of the cards physically. In addition, the ability of sending status information to the security center using GSM modules/Ethernet/Wi-Fi/Dry contacts/Different protocols etc. communication means through the serial ports and warning the user audibly that the payment station is under risk and should not be used by means of the mini audio messages with pre-recorded announcement. As a supplemental security measure, the cabin access cover control using an access control switch in order to prevent unauthorized access to the cabin, in which the payment station system is installed, is provided as a complimentary part of the solution.

This invention is easy to install due to the utilization of a card reader entrance with integrated dual sensors and dual antenna in order to reduce the risks associated with the card readers capable of bi-directional reading. It has a high accuracy in detecting objects. In can collect and evaluate the data to be received from the sensors installed in multiple surfaces thanks to the sensor bus structure that can accommodate multiple sensors connected. The said invention may also be used in a master-slave solution configuration by means of the multiple bezel use integrated in to our solutions for the payment stations.

### REFERENCE LIST

1. Central processor
2. Communication module
3. Sensor-1
4. Access control switches
5. Jamming emitter unit
6. Group of Antennas
7. Alarm panel outputs
8. Data logger
9. Real Time Clock
10. Sensor-2
11. Micro Shutter
12. LVDT Sensor
13. Voice Module
14. Antenna-1
15. Card insertion slot
16. Antenna-2
17. IR sensor transmitter
18. IR sensor Receiver
19. Flat Cable

### BRIEF EXPLANATION OF THE DRAWINGS

FIG. 1. The card insertion section on the external surface of the payment machine (viewed from inside) FIG. 2. The block diagram of the controller box that controls the antenna and sensors.

### EXPLANATION OF THE INVENTION

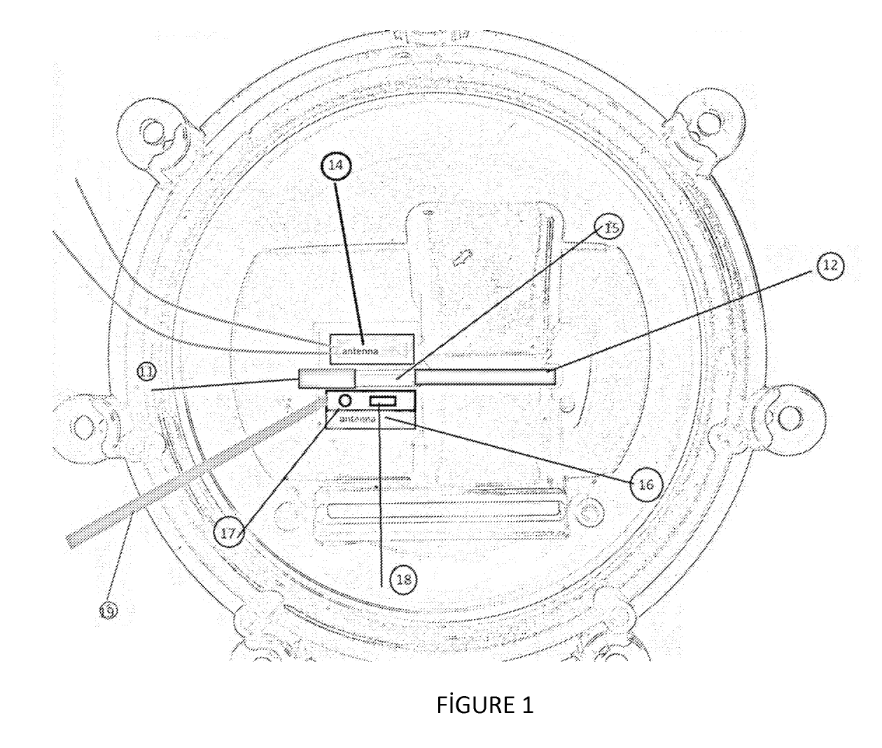

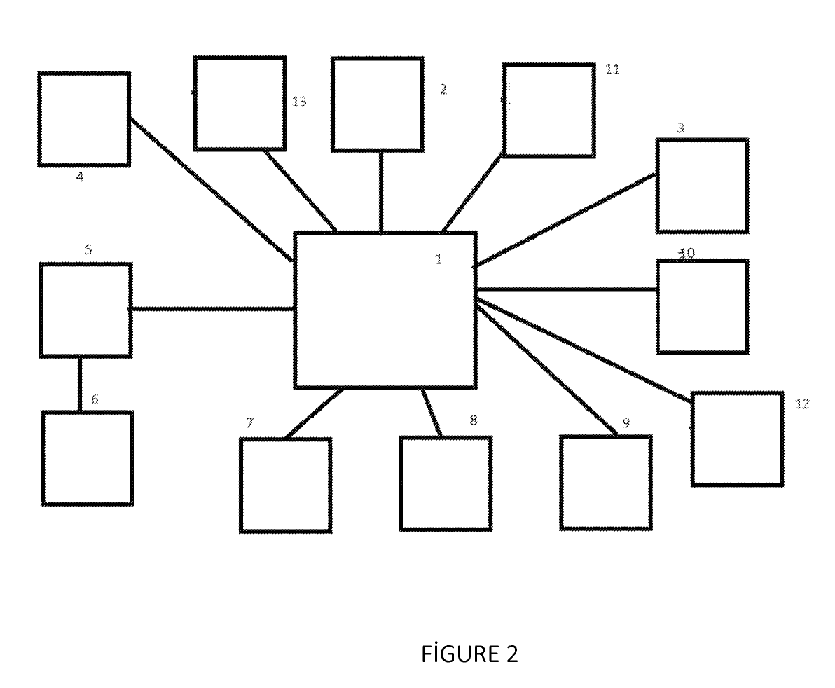

This invention is comprised of specially manufactured bezels with integrated multiple antennas that broadcast a jamming signal and the sensors that detect any foreign objects, which are suitable for transmitting the IR Led and sensor communications (the card insertion section on the outside of the payment station-FIG. 1) and a controller box that controls the antenna and sensor. The bezels shown in FIG. 1 may change according to the payment station make and models and the antennas and sensors may be used integrated in to the bezels of different design. The Bezel and Controller box structure is shown in FIG. 1 and FIG. 2.

This invention is a device that can be used in the card readers installed in both types of card-operated payment stations (DIP and motorized), which the people use for payments directly, developed for preventing the theft of the personal data stored in the payment card, to analyze and determine the foreign objects inserted in to the intake slot of the card reader, to emit disruptive signals in order to prevent copying attempts, to send warning signals through various channels and issue audible warnings and to maintain the records of the events on the device. It consists of a central processor (1), sensor-1 (3), jamming emitter unit (5), data logger (8), sensor-2 (10), access control switches (4), Real-time clock (9), and communication module (2), alarm panel outputs (7) and jamming antenna/antennas (6).

The software in the Central processor (1) processes the data received from the sensor-1 (3) or sensor-2 (10). The software in the Central processor (1) processes the dynamic data and determines the new adaptive reference values. The Sensor-1 (3) detects the changes in the card reader entrance and sends the data to the central processor in form of digital values.

The software for the Jamming emitter unit (5) emits random signals generated with a special algorithm that uses HW and SW components at a level that can prevent copying and difficult to filter out.

The Data logger (8) keeps the records of the system-generated and other events detected in the format prescribed (copying attacks, disabling attempts against the unit and status information etc.).

Sensor-2 (10); Different forms of attacks are detected using different sensors.

Communication module (2); GSM Module, Ethernet, RS232, RS485 and USB provide the appropriate communication channels compliant with the different monitoring center comm. Protocols.

Alarm panel output (7); is an alternative that can be used in place of the communication module (2) when the Dry Contact and GSM output network infrastructure is not available and allows communications between the central processor (1) and monitoring central.

Operating Principle;

The Central processor (1) module checks the proper operation of the other modules by means of the feedback signals received and if all the other modules are operating properly, it reads the data received from the sensor-1 (3) module. After analyzing the data received, it detects whether there is a card copying device or if the operation is carried out normally. If a copying device is detected, it activates the jamming emitter device (5) to broadcast a jamming signal. (In such a case) based on the requirements of the customers, it cuts off the power to the card reader causing the micro shutter (11) triggered to close the card entry slot. After evaluating the information received from the LVDT sensor (12), it detects the insertion of a foreign object etc. in to the slot. If required, it activates the voice module (13). It sends an alarm signal to the alarm panel through the communication module (2) and alarm panel outputs (7) to notify the monitoring center about the presence of an attack.

1. A device designed for protecting the data used in the payment stations, to detect any foreign objects or copying devices installed, to disrupt the data with a jamming signal, to issue warning notices and recording the status information, which is characterized by having a central processor, an IR sensor transmitter, an IR sensor Receiver, a jamming emitter unit, a data logger, a sensor-1, a sensor-2, and a communication module or alarm panel output and jamming emitter unit.

2. The device described in claim 1, wherein the device is capable of sending an error signal without modifying the current error tracking protocols and having an output for cutting off the power to the card reader by inducing the card reader to issue an alarm.

3. The device described in claim 1, having cover security switches, which report any attempt for copying in the payment system or access to the interior of the system to the monitoring center, thus allowing to check if event was a planned access or an unauthorized access.

4. The device described in claim 1, having a central processor that evaluates the data received from sensor-1 or sensor-2 by means of the resident software in order to assess the dynamic data and generate new adaptive reference values.

5. The device described in claim 1, having a sensor-1 that operates digitally to detect the changes in the card reader insertion opening, digitizes the said data and sends them to the central processor.

6. The device described in claim 1, having a jamming emitter device that emits random long-duration signals with both HW and SW support by means of the incorporated data processing and evaluation software at a level capable of preventing copying and impossible to filter out.

7. The device described in claim 1, having a data logger, which keeps the records of the events either self-generated or detected externally (copying attacks, external intervention for sabotage purposes, status information) on the incorporated memory card in the report format indicated.

8. The device described in claim 1, having access control switches that detect any intrusion etc. different forms of attack to the unit installed in and send warning messages.

9. The device described in claim 1, having the possibility of entering the date and time according to the time zone, where the device is installed, by means of the LCD screen/USB port on the central processor and/or the buttons installed.

10. The device described in claim 1, having a communication module and alarm outputs that provide communication channels compliant with different monitoring center protocols using the alarm panel outputs compatible with Ethernet, RS232, RS 485, USB and various other alarm panels.

11. The device described in claim 1, having the ability to run various cycles to emit the jamming signal when a foreign object is placed in front of the card reader and not when the card is inserted and/or ejected and to prevent any false alarms.

12. The device described in claim 1, having the ability of connecting to a GSM module in order to create the communication infrastructure at the locations, where the Internet infrastructure is not available.

13. The device described in claim 1, having the ability of Sensor-1 (to control the card reader entrance while reducing the margin of error by sending digital values and making cross checks.

14. The device described in claim 1, having an ease of installation using a group of antennas integrated to the reader intake that broadcast a jamming signal and the ability of jamming the signals from close proximity without affecting the card reader adversely.

15. The device described in claim 1, being capable of generating sensor and jamming signals for the card readers on each pump of the gas stations that are managed by the master module connected to the central and allowing to display the status information on the incorporated LCD screen.

16. The device described in claim 1, having an LVDT sensor that enables detecting any foreign object, card etc. insertion by evaluating the available data.

17. The device described in claim 1, having a micro shutter that is used for cutting off the power to the card reader closing the card entrance in order to prevent using the card.

18. The device described in claim 1, having a voice module that generates audible warnings.

19. The device described in claim 1, having the ability to be programmed remotely or through the close programming port connected to the processor in order to load a new object detection algorithm or the inputs and outputs.
